(19) United States
(12) Patent Application Publication
(10) Pub. No.: US 2025/0334068 A1
(43) Pub. Date: Oct. 30, 2025

(54) ORIENTED VALVE IGNITION CHAMBER

(71) Applicant: VIANNEY RABHI, LYON (FR)

(72) Inventor: VIANNEY RABHI, LYON (FR)

(21) Appl. No.: 19/212,956

(22) Filed: May 20, 2025

Related U.S. Application Data
(60) Provisional application No. 63/650,050, filed on May 21, 2024.

(30) Foreign Application Priority Data
Jan. 27, 2005 (FR) 2500850

(51) Int. Cl. F02B 19/12; F02B 19/02

(52) U.S. Cl. CPC F02B 19/12; F02B 19/02

(57) ABSTRACT

An oriented valve ignition prechamber includes a lamination duct which opens into a combustion chamber via a non-magnetic prechamber tip in which a friction insert for an oriented valve is fixedly mounted. A guide pin valve is formed by a main valve body and an orientation pin which can translate in the friction insert. The guide pin valve has an outer peripheral circular valve body guide bearing surface and an outer peripheral circular pin guide bearing surface which cooperate respectively with an inner valve body guide cylinder and an inner orientation pin guide cylinder arranged in the friction insert for an oriented valve.

The present invention relates to an oriented valve ignition prechamber which forms an improvement of the valve ignition prechamber, which is the subject of the patent no. FR 3 061 743 published on 16 Aug. 2019 and belonging to the applicant.

The oriented valve ignition prechamber according to the present invention is advantageously combined with the main improvements of the valve ignition prechamber according to the patent FR 3 061 743, said improvements having been the subject of several patent applications.

Among said improvements, the “magnetic valve return device”, subject matter of French patent application no. 3 085 718 published on 13 Mar. 2020, or the “active prechamber ignition insert”, the French patent application of which has been filed on 13 May 2019 under no. 1904961, or the “inverted combustion directional valve ignition prechamber” which has formed the subject matter of French patent application no. 2001508 of 14 Feb. 2020, or also, the patent entitled “valve having a guide pin” published under no. WO2022079367 are noted.

All these patents and patent applications have in common, the fact of having, as most torch ignition devices do, according to the prior art, which are intended for reciprocating internal combustion engines, an ignition prechamber formed of a lamination cavity arranged in the cylinder head of an internal combustion engine.

The strategy that said patents, patent applications, and devices serve, is notably known as “Turbulent Jet Ignition”.

According to said patents and patent applications, the lamination cavity is, on the one hand, connected to the combustion chamber of the internal combustion engine by a lamination duct, and on the other hand, receives a lamination injector which can inject in said cavity, a pilot load, pressurised beforehand by compression means, said load being constituted of an oxidiser/fuel mixture, readily inflammable by means of a spark.

It is noted that the combustion chamber itself receives a main load which can be either non-diluted, or, diluted with air or with recirculated exhaust gases, the dilution making it possible, notably, to maximise the energy efficiency of the internal combustion engine.

Said patents and patent applications belonging to the applicant are distinguished from the state of the art, in that the lamination duct describes a valve closing-off seat on which a lamination valve can rest, to close said duct. In doing so, said valve isolates the lamination cavity from the combustion chamber of the internal combustion engine.

However, when said valve is moved away from said seat to rest on a chamber-side valve stop directly or by way of a damping chamber, as described in the French patent application no. 3 085 718, said valve forms with the lamination duct, a torch ignition prechamber, which communicates simultaneously on the one hand, with the lamination cavity, and on the other hand, with the combustion chamber by way of gas ejection orifices.

This particular configuration makes it possible to introduce a pilot load into the lamination cavity, which remains fully inflammable, whatever the nature and the composition of the main load formed in the combustion chamber. Indeed, said main load and said pilot load can no longer be mixed, as the two said loads are sealingly separated by the lamination valve.

This advantage is decisive, as the composition, the pressure and the temperature of the pilot load can be radically different from those of the main load.

The stratification valve thus allows to avoid one of the main pitfalls of the torch ignition prechambers that can be described as “open”, that is to say without a stratification valve, which, according to the prior art, imply that if a gas mixture difficult to ignite forms the main charge, said mixture also forms, in part and following a mixture undergone, the pilot charge in the ignition prechamber even if said charge has been introduced into said prechamber by an injector in the form of a pre-prepared oxidiser-fuel gas mixture, or has been formed in said prechamber by injection of an additional liquid or gaseous fuel.

Indeed, in the case of “open” prechambers, it results from the mixture between the main load and the pilot load that the latter is all the less capable of delivering a high ignition power than the ignition of the main load requires a high ignition power.

Conversely, and always in the case of “open” prechambers, when the main charges is formed of a barely diluted and very active mixture which only requires a low ignition power in order to avoid the combustion of said charge generating pressure gradients which are too high and noise in the main chamber, the pilot charge is too energetic, as it is partially formed of the mixture constituting the main charge from which it inherits pressure and temperature.

In other words, without the lamination valve which, according to the patent no. FR 3 061 743, allows to close the lamination duct, the pilot charge is necessarily partially formed from the mixture constituting the main charge and therefore, said pilot charge partially inherits the susceptibility for ignition and for the combustion of the main charge, and its energy content is directly linked to the pressure that said main charge imposes on it, which is contrary to the need.

Indeed, the less the main load is reactive, the more powerful the pilot load must be. Conversely, the more readily and rapidly the main load is burnable, the less energetic the pilot load must be to avoid a too-rapid combustion of said main load.

That is why the valve ignition prechamber of the patent FR 3 061 743 forms an autonomous torch ignition device the power of which can be freely adjusted, this to find the best compromise between efficiency, polluting emissions, and acoustic emissions of the internal combustion engine which receives it.

This being described, it is seen in the figures of patent WO2022079367 that, advantageously, an orientation pin emerges from the axial opening face which has the main valve body of the lamination valve, this to form a valve having a guide pin.

The orientation pin engages with an axial guide orifice in which it is housed with a small radial clearance, said orifice passing through a chamber-side valve stop. Thus, said pin can slide longitudinally in said orifice without ever fully exiting it. In doing so, said pin orients the valve having a guide pin in the lamination duct.

Upon reading the patent WO2022079367, it is also noted that the guide pin valve comprises a peripheral centring surface arranged on the periphery of its main valve body, said surface being able to come into contact with the internal wall of the lamination duct to centre said body in said duct.

In patent WO2022079367, a valve damping chamber is formed by the lamination duct, by an axial opening face, and by a chamber-side valve stop, the volume of said chamber being maximum when an axial closing-off face that the valve having a guide pin has, rests on a duct closing-off seat that the lamination duct has, and minimum when the axial opening face rests on the chamber-side valve stop.

The patent WO2022079367 also exposes that the guide pin valve can advantageously be, in full or in part, coated with a low-friction-coefficient material, resistant to abrasive wear, like a “Diamond Like Coating” or a physical vapour deposition, such as “lonbond 90” developed by the company “lonbond” of the groupe “IHI”, however, that the internal surfaces of the lamination duct which come into contact with said valve are, for example, coated with low rate phosphorus chemical nickel.

As can be seen in the figures of patent WO2022079367, the lamination duct comprises a copper or stainless steel non-magnetic prechamber tip, coated or not with an antifriction material, highly resistant to abrasion.

The non-magnetic character of the material constituting the prechamber tip is necessary for the magnetic valve return device, which is the subject matter of French patent application no. 3 085 718, without which the valve having a guide pin cannot close rapidly enough, particularly when said valve is applied to high revolution rotating engines, such as those which equip cars.

In the figures of patent WO2022079367, it is noted that the prechamber tip is mounted fretted either side between a gas ejection tube and a non-magnetic sleeve insert, said tip receiving the chamber-side valve stop and the axial guide orifice which accommodates the orientation pin with a small clearance.

The non-magnetic insert sleeve can receive a duct closure seat which cooperates with an axial closure face arranged on the main valve body to close the lamination duct, said seat being able to receive an abrasion-resistant and impact-resistant hard treatment such as the “Tribobond 15”.

It is noted that the non-magnetic prechamber tip must be made of a material which is not only non-magnetic to be compatible with the magnetic valve return device which is the subject of the French patent application no. 3 085 718, but which has a high thermal conductivity, like copper, so as to avoid the temperature of said tip becoming excessive, the latter being directly exposed to the hot gases present in the combustion chamber of the internal combustion engine.

Indeed, if the non-magnetic prechamber tip is too hot, it can cause the unintentional self-ignition of the main load contained in the combustion chamber, which could lead to the destruction of the internal combustion engine.

The problem is that copper or the copper alloy from which the non-magnetic prechamber tip can advantageously be made is a ductile and malleable material that it is necessary to coat with a hard coating to make it resistant to abrasive wear induced by its friction with the peripheral centring surface of the guide pin valve, on the one hand, and to that induced by the friction of the orientation pin with the axial guide orifice, on the other hand.

Coating copper or copper alloy is however not adapted to the functional context of the guide pin valve, as soon as this relates to guaranteeing a long service life to the guide pin valve prechamber which results from the combination of the patents no. FR 3 061 743 and no. WO2022079367.

Indeed, the torch ignition prechamber is subject to a high thermal load when ignition torches are ejected from said prechamber via gas ejection orifices, at temperatures greater than two thousand degrees Celsius.

For example, the chemical nickel coating is compatible with highly mechanical resistant copper alloys, like “C17500”, but said coating is not resistant enough to temperature and abrasion to meet the operational specifications of the prechamber with a valve having a guide pin according to patent no. WO2022079367.

Indeed, in practice, the chemical nickel coating rapidly loses its mechanical properties with temperature, and it is repelled by the lamination valve, even, is deposited on said valve by succession of micro fusions.

The problem is that copper cannot receive coatings resistant to very high temperature, which are ordinarily applied to temperatures of between five hundred and eight hundred degrees Celsius.

A solution could consist of replacing copper with non-magnetic stainless steel, but said steel has an insufficient thermal conductivity.

It is therefore to solve the different problems which have just been described and the resulting dilemmas that according to the oriented valve ignition prechamber according to the invention and according to a particular embodiment of said prechamber, the lamination valve and the orientation pin which form the guide pin valve are no longer guided directly by the material constituting the non-magnetic prechamber tip, but by way of guide means made of a hard material, resistant to abrasion, and compatible with the most effective antifriction coatings which are generally deposited at a high temperature.

In this regard, a valve ignition prechamber results from the oriented valve ignition prechamber according to the invention:
The non-magnetic prechamber tip of which can be made with a highly thermally conductive non-magnetic material, such as copper, without prejudice for the mechanical strength and the service life of said tip;
The service life of which is compatible with that of a car engine produced in large series, and the operation of which remains stable during said service life, guaranteeing to the internal combustion engine which receives it, an optimal efficiency and operation during its whole service life;
The large series manufacture of which does not reveal any particular difficulty;
The cost price of which is compatible with the economical constraints of the markets for cars produced in very large series.

It is understood that the oriented valve ignition prechamber according to the invention can not only be applied to the guide pin valve prechamber according to the patent no. WO2022079367, but also to any other application close in its design and in its principle which could advantageously exploit the features and functionalities of said prechamber.

The oriented valve ignition prechamber according to the invention is arranged in an internal combustion engine cylinder head which caps a combustion chamber, said prechamber comprising a lamination cavity in which ignition means and a lamination injector open, said cavity being connected to the combustion chamber by a lamination duct which opens in said chamber in the form of a non-magnetic prechamber tip in which can translate a lamination valve which includes a main valve body, the latter including, on the side of the lamination cavity, an axial closure face that can cooperate with a duct closure seat arranged in the lamination duct to close the last mentioned however that said valve is oriented by an orientation pin which emerges from the main valve body and can slide in an axial guide orifice arranged in said tip, said body and said pin together forming a guide pin valve, while the non-magnetic prechamber tip forms with said valve and when this does not close the lamination duct, a torch ignition prechamber, which connects the lamination cavity to the combustion chamber by way of at least one gas ejection orifice, comprises:
A friction insert for an oriented valve which is fixedly mounted in the non-magnetic prechamber tip and which houses wholly or partly the guide pin valve, said insert replacing the non-magnetic prechamber tip to house the axial guide orifice.
At least one outer peripheral circular valve body guide bearing surface arranged as a projection and on the outer periphery of the main valve body, said bearing surface being, at least in part, resistant to abrasive wear;
At least one outer peripheral circular pin guide bearing surface arranged as a projection and on the outer periphery of the orientation pin, said bearing surface being resistant to abrasive wear;
At least one inner valve body guide cylinder which is arranged in the friction insert for an oriented valve and which houses wholly or partly the main valve body, the latter being able to translate in said cylinder in which it is guided by the outer peripheral circular valve body guide bearing surface, the inner diameter of said cylinder being substantially greater than the outer diameter of said bearing surface while the inner surface of said cylinder is, at least in part, resistant to abrasive wear.
At least one inner orientation pin guide cylinder which the axial guide orifice has and which houses wholly or partly the orientation pin, the latter being able to translate in said cylinder in which it is guided by the outer peripheral circular pin guide bearing surface, the inner diameter of said cylinder being substantially greater than the outer diameter of said bearing surface while the inner surface of said cylinder is, at least in part, resistant to abrasive wear.

The oriented valve ignition prechamber according to the invention comprises a friction insert for an oriented valve which is made of a non-magnetic material with high thermal and mechanical resistance.

The oriented valve ignition prechamber according to the invention comprises a friction insert for an oriented valve which forms, with an axial opening face oriented towards the combustion chamber that the main valve body has, on the one hand, and with the orientation pin, on the other hand, a valve damping chamber.

The oriented valve ignition prechamber comprises according to the invention an axial guide orifice which has a damping counterbore at its end which opens into the valve damping chamber, said counterbore cooperating with a damping shoulder that the orientation pin comprises.

The oriented valve ignition prechamber according to the invention comprises a damping counterbore which is directly or indirectly connected to the combustion chamber by at least one depressurising duct.

The oriented valve ignition prechamber according to the invention comprises a main valve body which comprises at its outer periphery a secondary sealing collar in the extension of the outer peripheral circular valve body guide bearing surface, the outer diameter of said collar being less than the outer diameter of said bearing surface.

The oriented valve ignition prechamber according to the invention comprises a friction insert for an oriented valve which is fixedly mounted in the non-magnetic prechamber tip by means of an elastic washer held in place in the non-magnetic prechamber tip by a circular stop ring housed in a stop ring groove provided in said tip.

The oriented valve ignition prechamber according to the invention comprises an axial face of the circular stop ring which is in contact with the elastic washer which comprises a locking shoulder which can come into contact with the periphery of said washer, said shoulder preventing said ring from leaving the stop ring groove.

The oriented valve ignition prechamber according to the invention comprises an friction insert for an oriented valve that is screwed into the non-magnetic prechamber nose by means of an insert thread that said insert has, said thread cooperating with a prechamber nose thread that the non-magnetic prechamber nose has.

The oriented valve ignition prechamber according to the invention comprises an friction insert for an oriented valve which is divided into three insert parts, the first insert part receiving the inner valve body guide cylinder, the second insert part forming an insert mounting body, and the third insert part receiving the inner orientation pin guide cylinder.

The oriented valve ignition prechamber according to the invention comprises a lamination duct that forms a gas ejection tube at the end of which the duct closure seat is arranged while a magnetic field source induces a magnetic field in said tube, said field attracting the lamination valve to said tube and tending to return said valve into contact with the duct closure seat.

The oriented valve ignition prechamber according to the invention comprises a gas ejection tube which receives a non-magnetic fitted sleeve on which the duct closure seat is arranged.

The oriented valve ignition prechamber according to the invention comprises a channeling groove for the magnetic flux which is arranged at the periphery of the gas ejection tube (25) and in the vicinity of the duct closure seat.

The following description given by way of non-limiting examples and with reference to the accompanying drawings, makes it possible to understand the invention better, and to understand the features that it presents, and the advantages that it is likely to provide:

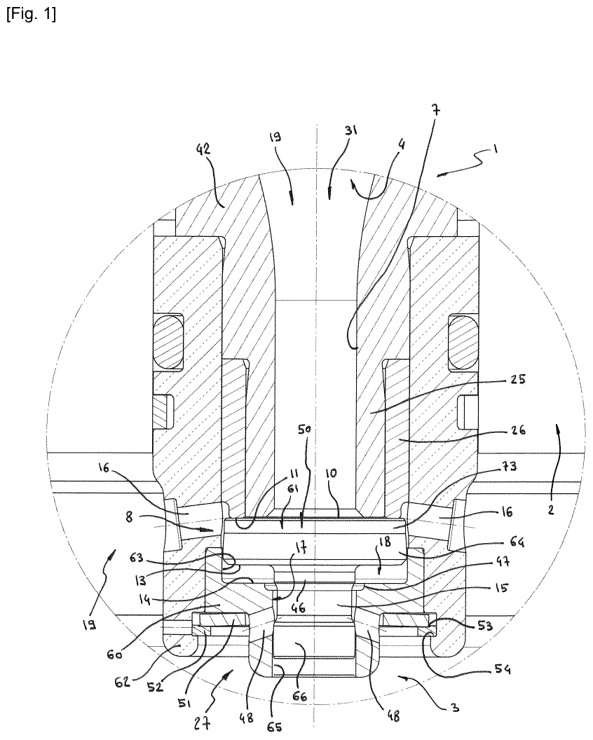

FIG. 1 is a partial schematic cross-sectional view of the oriented valve ignition prechamber according to the invention, said view being centred on the friction insert for an oriented valve which is fixedly mounted in the non-magnetic prechamber tip by means of an elastic washer itself held in place by a circular stop ring housed in a stop ring groove made in said tip, the guide pin valve being closed, that is to say closing the lamination duct while the volume of the valve damping chamber is maximal.

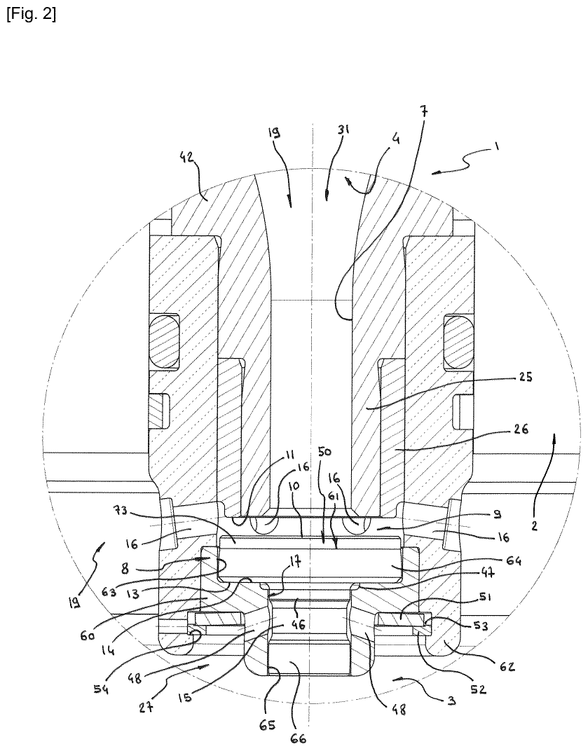

FIG. 2 is a partial schematic cross-sectional view of the oriented valve ignition prechamber according to the invention and according to the variant shown in FIG. 1, the guide pin valve being open and its axial opening face resting on the chamber-side valve stop, said valve forming, with the non-magnetic prechamber tip, a torch ignition prechamber, while the lamination duct is connected to the combustion chamber, and that the volume of the valve damping chamber is minimal.

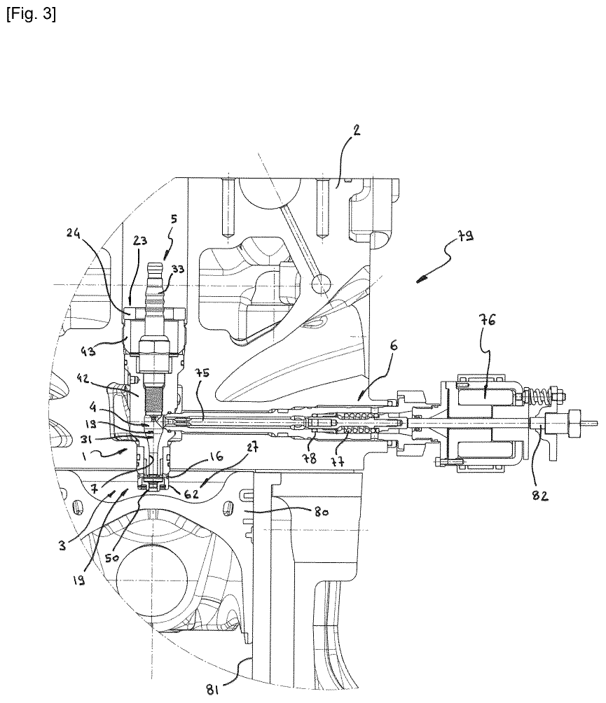

FIG. 3 is a schematic cross-sectional view of the oriented valve ignition prechamber according to the invention and according to the variant shown in FIG. 1, in the environment of an internal combustion engine which receives said prechamber, the friction insert for an oriented valve taking place at the end of an active prechamber ignition insert such as described in the French patent application no. 1904961 belonging to the applicant, and cooperating with a spark plug and an electromechanically controlled lamination injector.

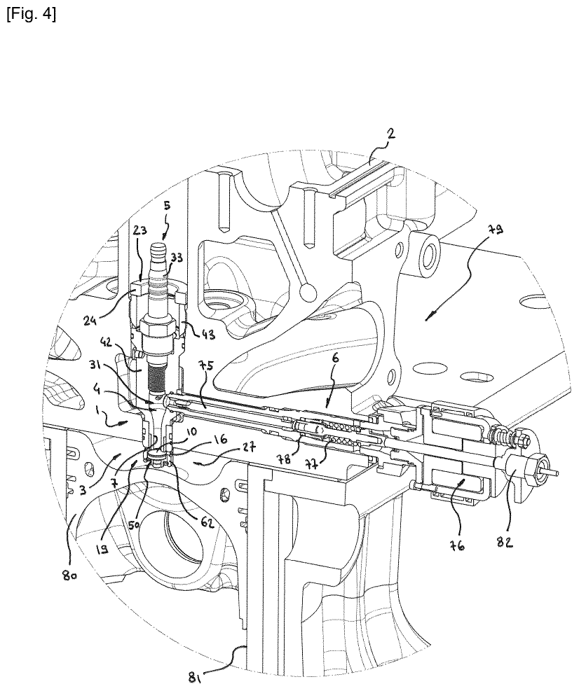

FIG. 4 is a three-dimensional view of the oriented valve ignition prechamber according to the invention in the environment of an internal combustion engine, made from the schematic cross-section shown in FIG. 3.

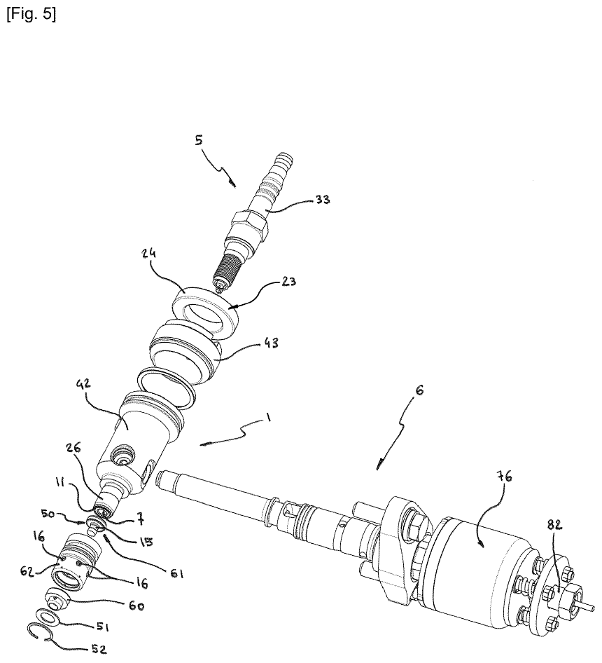

FIG. 5 is an exploded three-dimensional view of the oriented valve ignition prechamber according to the invention and according to the variant and the environment shown in FIGS. 1 to 4, but without the internal combustion engine.

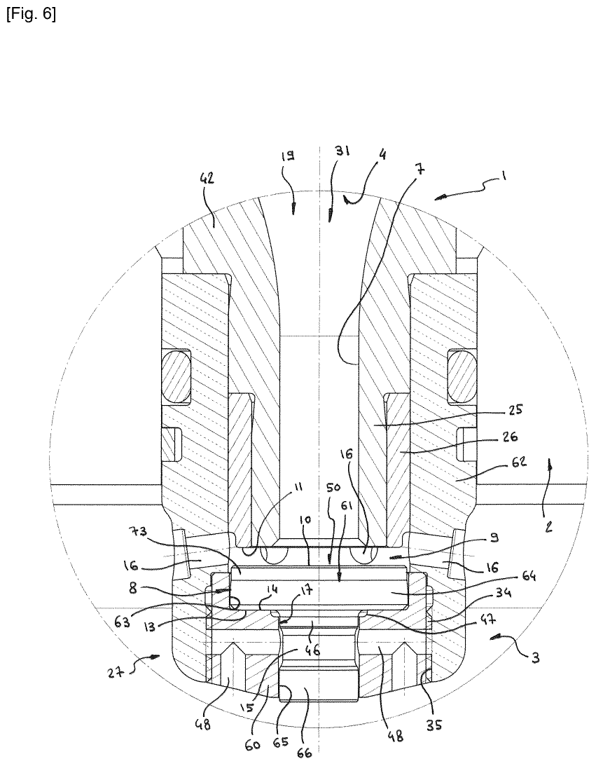

FIG. 6 is a partial schematic cross-sectional view of the oriented valve ignition prechamber according to the invention, said view being centred on the friction insert for an oriented valve which is screwed into the non-magnetic prechamber nose by means of an insert thread and a prechamber nose thread, while the guide pin valve is open to form with the non-magnetic prechamber nose a torch ignition prechamber, the volume of the valve damping chamber being minimal.

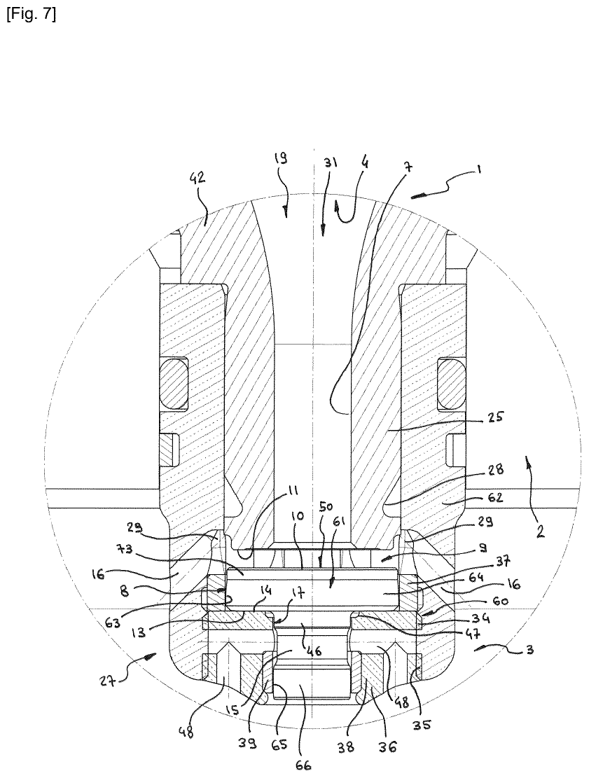

FIG. 7 is a partial schematic cross-sectional view of the oriented valve ignition prechamber according to the invention, said view being centred on the friction insert for an oriented valve which is divided into three insert parts, the first receiving the inner valve body guide cylinder, the second forming an insert mounting body, and the third receiving the inner orientation pin guide cylinder, while the guide pin valve is open to form with the non-magnetic prechamber nose a torch ignition prechamber, the volume of the valve damping chamber being minimal.

### DESCRIPTION OF THE INVENTION

FIGS. 1 to 7 show the oriented valve ignition prechamber 1 according to the invention, various details of its components, its variants, and its accessories.

As FIGS. 1 to 4 and FIGS. 6 and 7 show, the oriented valve ignition prechamber 1 is mainly intended for installation in an internal combustion engine cylinder head 2 capping a combustion chamber 3, said prechamber 1 comprising a lamination cavity 4 in which ignition means 5 and a lamination injector 6 open.

As can be seen in FIGS. 1 to 7, the lamination cavity 4 is connected to the combustion chamber 3 by a lamination duct 7 which opens into said chamber 3 in the form of a non-magnetic prechamber tip 62.

It is noted in FIGS. 1 to 7 that a lamination valve 61 can translate in the non-magnetic prechamber tip 62, said valve 61 comprising a main valve body 8 which has, on the side of the lamination cavity 4, an axial closure face 10, the latter being able to cooperate with a duct closure seat 11 arranged in the lamination duct 7 to close the latter 7.

It is noted in FIGS. 1 to 7 that the lamination valve 61 is oriented by an orientation pin 15 which emerges from the main valve body 8 and which can slide in an axial guide orifice 17 arranged in said tip 62, said body 8 and said pin 15 together forming a guide pin valve 50.

As has been shown in a particularly visible manner in FIGS. 2, 6 and 7, the non-magnetic prechamber tip 62 forms with the guide pin valve 50, when the latter does not close the lamination duct 7, a torch ignition prechamber 9 which connects the lamination cavity 6 to the combustion chamber 3 by means of at least one gas ejection orifice 16.

It can be seen in FIGS. 1 to 7 that the oriented valve ignition prechamber 1 according to the invention comprises an friction insert 60 for an oriented valve, consisting of a single piece as shown in FIGS. 1 to 6 or which is formed of several assembled pieces as shown in FIG. 7, said insert 60 being fixedly mounted in the non-magnetic prechamber tip 62.

It is noted that the friction insert 60 for an oriented valve could be, by way of a variant not shown, formed of two distinct parts included in the non-magnetic prechamber tip 62, the first part forming the inner valve body guide cylinder 63 while the second forms the inner orientation pin guide cylinder 65.

The friction insert for an oriented valve 60 shown in FIGS. 1 to 7 can house wholly or partly the guide pin valve 50, said insert 60 replacing the non-magnetic prechamber tip 62 to house the axial guide orifice 17.

In a particularly visible manner in FIGS. 1, 2, 6 and 7, it will be noted that the oriented valve ignition prechamber 1 according to the invention also comprises at least one outer peripheral circular valve body guide bearing surface 64 arranged as a projection and on the outer periphery of the main valve body 8, said bearing surface 64 being, at least in part, resistant to abrasive wear.

As illustrated in FIGS. 1, 2, 6 and 7, the outer peripheral circular valve body guide bearing surface 64 may advantageously have a domed axial profile that prevents said bearing surface 64 from exposing a sharp edge.

In a similar manner, the oriented valve ignition prechamber 1 according to the invention also comprises at least one outer peripheral circular pin guide bearing surface 66 arranged a projection and on the outer periphery of the orientation pin 15, said bearing surface 66 being resistant to abrasive wear.

It should be noted in FIGS. 1, 2, 6 and 7 that the outer peripheral circular pin guide bearing surface 66 can also and advantageously have a domed axial profile that prevents said bearing surface 66 from exposing a sharp edge.

In FIGS. 1, 2, 6 and 7, it has also been illustrated that the oriented valve ignition prechamber 1 according to the invention also comprises at least one inner valve body guide cylinder 63 which is arranged in the friction insert for an oriented valve 60 and which houses wholly or partly the main valve body 8.

It should be noted that the main valve body 8 can translate in the inner valve body guide cylinder 63 in which it is guided by the outer peripheral circular valve body guide bearing surface 64, the inner diameter of said cylinder 63 being substantially greater than the outer diameter of said bearing surface 64 while the inner surface of said cylinder 63 is, at least in part, resistant to abrasive wear.

FIGS. 1, 2, 6 and 7 also show that the oriented valve ignition prechamber 1 according to the invention also comprises at least one inner orientation pin guide cylinder 65 that the axial guide orifice 17 has and which houses wholly or partly the orientation pin 15.

It is noted that the orientation pin 15 can translate in the inner orientation pin guide cylinder 65 in which it is guided by the outer peripheral circular pin guide bearing surface 66, the inner diameter of said cylinder 65 being substantially greater than the outer diameter of said bearing surface 66 while the inner surface of said cylinder 65 is, at least in part, resistant to abrasive wear.

It should be noted that according to the oriented valve ignition prechamber 1 according to the invention, the friction insert for an oriented valve 60 can advantageously be made of a non-magnetic material with high thermal and mechanical resistance.

As an alternative to the oriented valve ignition prechamber 1 according to the invention particularly visible in FIGS. 1, 2, 6 and 7, the friction insert for an oriented valve 60 can form, with an axial opening face 13 oriented towards the combustion chamber 3 that the main valve body 8 has, on the one hand, and with the orientation pin 15 on the other hand, a valve damping chamber 18.

In this case, when the guide pin valve 50 is opened to form a torch ignition prechamber 9 with the non-magnetic prechamber tip 62, the valve damping chamber 18 dampens the possible impact which could occur between the axial opening face 13 which is provided by said valve 50 and a chamber-side valve stop 14 which stops said valve 50 in its stroke in the direction of the combustion chamber 3, said stop 14 being none other than the bottom of the valve damping chamber 18.

In this case, the axial guide orifice 17 can advantageously have a damping counterbore 47 at its end which opens into the valve damping chamber 18, said counterbore 47 cooperating with a damping shoulder 46 that the orientation pin 15 comprises.

It is noted that the damping counterbore 47 and the damping shoulder 46 are positioned such that the valve having a guide pin 50 can cover the first part of its stroke towards the chamber-side valve stop 14 by being slowed down as little as possible by the valve damping chamber 18.

Indeed, while the damping shoulder 46 has not arrived at the damping counterbore 47, the gases 19 contained in the valve damping chamber 18 can freely exit from the latter in the direction of the combustion chamber 3, via the clearance left between said shoulder 46 and said counterbore 47, then via the depressurising ducts 48.

When the damping shoulder 46 arrives at the damping counterbore 47, the gases 19 are found highly laminated by the passage restriction thus formed, such that during the second part of its stroke towards the chamber-side valve stop 14, the valve 50 having a guide pin is slowed down, which reduces the power of any impact which could occur between the axial opening face 13 and the chamber-side valve stop 14.

This particular configuration of the friction insert for an oriented valve 60 and of the guide pin valve 50 gives the latter a long service life.

According to this last variant, it is noted in FIGS. 1, 2, 6 and 7 that the damping counterbore 47 can be directly or indirectly connected to the combustion chamber 3 by at least one depressurising duct 48.

FIGS. 1, 2, 6 and 7 illustrate that according to another alternative embodiment of the oriented valve ignition prechamber 1 according to the invention, the main valve body 8 can comprise at its outer periphery a secondary sealing collar 73 in the extension of the outer peripheral circular valve body guide bearing surface 64, the outer diameter of said collar 73 being less than the outer diameter of said bearing surface 64.

It will be noted that the secondary sealing collar 73 forms a labyrinth or a baffle which opposes resistance to the passage of gases 19 which enter or leave the valve damping chamber 18.

As another alternative embodiment of the oriented valve ignition prechamber 1 according to the invention, particularly visible in FIGS. 1, 2 and 5, the friction insert for an oriented valve 60 can be fixedly mounted in the non-magnetic prechamber tip 62 by means of an elastic washer 51, for example of the “Belleville” type known per se, held in place in the non-magnetic prechamber tip 62 by a circular stop ring 52 housed in a stop ring groove 54 made in said tip 62.

In this case, the circular stop ring 52 and the elastic washer 51, can advantageously be made of a non-magnetic, stainless metal, and preserving a high mechanical resistance to high temperatures, such as “Inconel”.

Still in this case, the axial face of the circular stop ring 52 which is in contact with the elastic washer 51 can advantageously comprise a locking shoulder 53 which can come into contact with the periphery of said washer 51, said shoulder 53 preventing said ring 52 from leaving the stop ring groove 54.

It is noted in FIG. 7 that the gas ejection orifices 16 can each receive an inlet arch 29 which is arranged in the non-magnetic prechamber tip 62 and which is interposed between the torch ignition prechamber 9 and the gas ejection orifice 16 with which it cooperates.

This particular configuration of the oriented valve ignition prechamber 1 according to the invention allows the gas ejection orifices 16 to form a very closed angle with the longitudinal axis of the non-magnetic prechamber tip 62.

FIGS. 6 and 7 show that according to the oriented valve ignition prechamber 1 according to the invention, the oriented valve friction insert 60 can be screwed wholly or partly into the non-magnetic prechamber tip 62 by means of an insert thread 34 that said insert 60 has, said thread 34 cooperating with a prechamber nose thread 35 that the non-magnetic prechamber tip 62 has.

It should be noted that the insert thread 34 can be male and the prechamber nose thread 35 female, or vice versa.

Whatever the screwed configuration, the friction insert 60 for an oriented valve can, once screwed into or around the non-magnetic prechamber tip 62 62, be stopped in rotation by stop means (not shown) such as at least one tongue, the flap on the one hand of the constituent material of the non-magnetic prechamber tip 62 in at least one housing or slot arranged in the insert thread 34, at least one pin, or by any other stop means known to the person skilled in the art.

FIG. 7 shows that the friction insert 60 for an oriented valve can be divided into three insert parts 37, 38, 39, the first insert part 37 receiving the inner valve body guide cylinder 63, the second insert part 38 forming an insert mounting body 36, while the third insert part 39 receives the inner orientation pin guide cylinder 65.

This particular configuration of the oriented valve ignition prechamber 1 according to the invention makes it possible for each insert part 37, 38, 39 to be made of one or more materials which are as suitable as possible for the function assigned to each said part 37, 38, 39.

FIG. 7 also shows that the lamination duct 7 can form a gas ejection tube 25 at the end of which the duct closure seat 11 is arranged while a magnetic field source 23 induces a magnetic field in said tube 25, said field attracting the lamination valve 61 towards said tube 25 and tending to return said valve 61 into contact with the duct closure seat 11.

As shown in FIGS. 1, 2, 5, 6, and 7, the gas ejection tube 25 can receive a non-magnetic insert sleeve 26 on which the duct closure seat 11 is arranged.

Nevertheless, whatever the configuration chosen for the gas ejection tube 25, a channeling groove for the magnetic flux 28 can be provided at the periphery of the gas ejection tube 25 and in the vicinity of the duct sealing seat 11, said groove 28 making it possible to increase the efficiency of the magnetic field produced by the magnetic field source 23 in attracting the lamination valve 61 and in returning the latter into contact with the duct sealing seat 11.

It will be noted that the channeling groove for the magnetic flux 28 can adopt any shape imaginable by the person skilled in the art, without restriction.

### OPERATION OF THE INVENTION

The operation of the oriented valve ignition prechamber 1 according to the invention is easily understood at the view of FIGS. 1 to 7.

FIGS. 3 to 4 show the environment of the invention which is mainly constituted of the internal combustion engine cylinder head 2 of an internal combustion engine 79, the latter comprising a piston 80 and a cylinder 81 which form, with said cylinder head 2, a combustion chamber 3.

It has been particularly shown in FIGS. 1 to 4 and in FIGS. 6 and 7, that the lamination duct 7 has a gas ejection tube 25 made, according to this example, of stainless steel with high magnetic permeability and low magnetic remanence, said duct 7 also comprising, according to the variants which are particularly visible in FIGS. 1, 2 and 6, a non-magnetic insert sleeve 26 which is made, for example, of “Inconel 718”, which is mounted fretted on the gas ejection tube 25, and which receives the duct closure seat 11, the latter being able to receive an abrasion-resistant and impact-resistant hard treatment such as the “Tribobond 15”.

According to a particular configuration, the non-magnetic insert sleeve 26 can be made of hardened magnetic steel with high hardness at the core, such as the “Caldie” from the company “Uddeholm”, said steel being coated with a layer with a low coefficient of friction and even harder and resistant to abrasion and impacts, such as the “Tribobond 15”.

FIG. 7 shows that the lamination duct 7 may not receive a non-magnetic insert sleeve 26, the duct closure seat 11 being in this case arranged directly at the end of the gas ejection tube 25.

If the non-magnetic insert sleeve 26 is, according to a particular embodiment of the oriented valve ignition prechamber 1 according to the invention, made of magnetic steel whatever its nature, said sleeve 26 can receive a magnetic flux channeling groove 28 like that shown in FIG. 7, said groove 28 being arranged directly on the periphery of the gas ejection tube 25.

The magnetic flux channeling groove 28 makes it possible to distort the shape of the magnetic field at the duct sealing seat 11, which has the effect of amplifying the magnetic return force of the guide pin valve 50 on the duct sealing seat 11 with which it cooperates.

In FIGS. 1 to 4 and in FIGS. 6 and 7, it can be seen that the lamination duct 7 opens out into the combustion chamber 3 in the form of a non-magnetic prechamber tip 62 made of a copper alloy, for example a Copper-Beryllium-Cobalt of the “C17500” type.

The “C17500” alloy has the advantage of being non-magnetic, in addition to offering a good compromise between high thermal conductivity on the one hand, and acceptable mechanical strength at high temperatures on the other hand.

In FIGS. 1, 4 and 6, it has been shown that the non-magnetic prechamber tip 62 can be mounted fretted either side between the gas ejection tube 25 and the non-magnetic insert sleeve 26, while in FIG. 7, said tip 62 is directly mounted on the gas ejection tube 25.

It is noted in FIGS. 1 to 7 that the non-magnetic prechamber tip 62 made of copper alloy houses a friction insert 60 for an oriented valve which is made of a non-magnetic material with high thermal and mechanical resistance such as “Inconel 718”.

In FIGS. 1 to 5, said insert 60 is fixedly mounted in the non-magnetic prechamber tip 62 by means of an elastic washer 51 held in place by a circular stop ring 52 housed in a stop ring groove 54 provided in said tip 62, while in FIGS. 6 and 7, it has been shown that said insert 60 can be screwed into said tip 62.

In general, it will be noted that the operation of the guide pin valve 50 in the friction insert for an oriented valve 60 is similar to that described in the patent No. WO2022079367, the purpose of said friction insert 60 not being to modify said operation, but to ensure great stability over time, and great durability for the latter and for the valve ignition prechamber 1 as a whole.

As has been shown in a particularly visible manner in FIGS. 1, 2 and 6, the friction insert for an oriented valve 60 is mounted fixedly in the non-magnetic prechamber tip 62 by means of an elastic washer 51 which is here and by way of example of the “Belleville” type, said washer 51 being held in place in said tip 62 by a circular stop ring 52 housed in a stop ring groove 54 provided in said tip 62.

As another non-limiting example, the elastic washer 51 and the circular stop ring 52 can advantageously be made of “Inconel”, a stainless and non-magnetic metal that retains a high mechanical strength at high temperatures.

Whatever the method of fixing in the non-magnetic pre-chamber tip 62, the friction insert 60 for an oriented valve can be at least locally mounted tightly in the non-magnetic prechamber tip 62 to ensure maximum thermal cohesion between said insert 60 and said tip 62 so that during the combustion of a main charge 27 in the combustion chamber 3, the heat that the friction insert for an oriented valve 60 receives from the hot gases 19 with which it is in contact can effectively be evacuated by conduction via the non-magnetic prechamber tip 62

An alternative may consist, on the contrary, in mounting the friction insert for an oriented valve 60 in the non-magnetic prechamber tip 62 with a slight clearance, in order to avoid any creeping movement of said insert 60 in said tip 62 following the slight shocks induced by the operation of the guide pin valve 50.

In FIG. 1, the valve 50 having a guide pin has been shown in the “fully closed” position, i.e. with its axial closing-off face 10 which is in contact with the conduit closing-off seat 11, such that the lamination duct 7 is closed off and that no gas 19 can circulate from the lamination cavity 4 to the combustion chamber 3 or conversely, the volume of the valve damping chamber 18 being maximum.

FIGS. 2, 6 and 7 shows the guide pin valve 50 in the “fully open” position, that is to say with its axial opening face 13 which is in contact with a chamber-side valve stop 14 that the friction insert 60 for an oriented valve has, so that the lamination duct 7 is also fully open.

The guide pin valve 50 being in said position shown in FIGS. 2, 6 and 7, it forms with the non-magnetic prechamber tip 62 a torch ignition prechamber 9 via which the gases 19 can flow from the lamination cavity 4 to the combustion chamber 3, the volume of the valve damping chamber 18 being minimal.

In FIGS. 1, 2, 6 and 7, it is noted that an outer peripheral circular valve body guide bearing surface 64 is arranged as a projection and at the outer periphery of the main valve body 8, said bearing surface 64 being made resistant to abrasive wear for example by applying thereto a surface coating such as “lonbond 90”.

It is noted that outer peripheral circular valve body guide bearing surface 64 cooperates with an inner valve body guide cylinder 63 which is arranged in the friction insert for an oriented valve 60 and which largely houses the main valve body 8, whether its axial closure face 10 is in contact with the duct closure seat 11 or not.

Thus, the guide pin valve 50 can translate in the inner valve body guide cylinder 63 in which it is guided by its outer peripheral circular valve body guide bearing surface 64.

To avoid jamming whether the internal combustion engine 79 is hot or cold, the inner diameter of the inner valve body guide cylinder 63 is always substantially larger than the outer diameter of the outer peripheral circular valve body guide bearing surface 64, while the inner surface of said cylinder 63 is made resistant to abrasive wear for example by means of a surface coating such as “lonbond 90”.

Similarly, it is noted in FIGS. 1, 2, 6 and 7 that an outer peripheral circular pin guide bearing surface 66 is provided as a projection and on the outer periphery of the orientation pin 15, said bearing surface 66 being made resistant to abrasive wear for example by also applying thereto a surface coating such as “lonbond 90”.

Similarly, the outer peripheral circular pin guide bearing surface 66 cooperates with an inner orientation pin guide cylinder 65 arranged inside the friction insert for an oriented valve 60, said cylinder 65 almost totally housing, according to the embodiment of the oriented valve ignition prechamber 1 according to the invention represented in FIGS. 1, 2, 6 and 7, the orientation pin 15, and this, whether the axial closure face 10 of the main valve body 8 is in contact with the duct closure seat 11, or is away from said seat 11.

Thus, the orientation pin 15 can translate in the inner orientation pin guide cylinder 65 in which it is guided by the outer peripheral circular pin guide bearing surface 66.

To avoid jamming whether the internal combustion engine 79 is hot or cold, the inner diameter of the inner orientation pin guide cylinder 65 is always substantially greater than the outer diameter of the outer peripheral circular pin guide bearing surface 66, while the inner surface of said cylinder 65 is made resistant to abrasive wear for example by means of a surface coating such as “lonbond 90”.

It is noted in FIGS. 1 and 7 that the outer peripheral circular valve body guide bearing surface 64 and the outer peripheral circular pin guide bearing surface 66 are in the form of a barrel of large radius, the latter having here and by way of non-limiting example a longitudinal radius of eight and twenty millimetres.

Such large radii lead to low contact pressures exerted during the operation of the internal combustion engine 79 by said bearing surfaces 64, 65 on their respective cylinders 63, 65.

Moreover, the particular configuration of the guide pin valve 50 according to the oriented valve ignition prechamber 1 according to the invention allows a simple and inexpensive mass production of said valve 50 compared to a solution which would provide, for example, a first valve body guide means made as a projection inside a friction insert fixed in the non-magnetic prechamber tip 62, the main valve body 8 being cylindrical, and a second orientation pin guide means made as a projection inside said insert, the orientation pin 15 also being cylindrical.

Indeed, the external grinding of the pin guide valve 50 of the oriented valve ignition prechamber 1 according to the invention remains simple and industrially accessible, even if the outer peripheral circular valve body guide bearing surface 64 and the outer peripheral circular pin guide bearing surface 66 are not cylindrical, and even if the manufacturing tolerances are tightened, of only a few microns.

The same applies to the internal cylindrical grinding necessary to finish the inner valve body guide cylinder 63 and the inner orientation pin guide cylinder 65 of the friction insert for an oriented valve 60 of the oriented valve ignition prechamber 1 according to the invention, said grinding remaining simple given the simplicity of the shapes to be machined.

It should also be noted that, insofar as, as provided by the oriented valve ignition prechamber 1 according to the invention, the orientation pin 15 comprises an outer peripheral circular pin guide bearing surface 66 provided as a projection from its outer periphery, the section that said pin 15 exposes to the pressure difference between that prevailing in the combustion chamber 3 of the internal combustion engine 79 and that prevailing in the torch ignition prechamber 9 when the guide pin valve 50 is open is applied to a larger section, which allows said pressure difference to exert a greater reclosure force on said valve 50, which gives the latter a more efficient operation when the internal combustion engine 79 operates at high speeds of rotation.

It is noted, particularly in FIGS. 1, 2, 6 and 7, that the orientation pin 15 comprises a damping shoulder 46 which engages with a damping counterbore 47 arranged at the inlet of the axial guide orifice 17, said counterbore 47 opening into the valve damping chamber 18.

This particular configuration of the friction insert for an oriented valve 60 and of the guide pin valve 50 makes it possible for the latter to cover the first part of its stroke to the chamber-side valve stop 14 by being slowed down as little as possible by the valve damping chamber 18.

Indeed, while the damping shoulder 46 has not arrived at the damping counterbore 47, the gases 19 contained in the valve damping chamber 18 can freely exit from the latter in the direction of the combustion chamber 3, via the clearance left between said shoulder 46 and said counterbore 47, then via the depressurising ducts 48.

When the damping shoulder 46 reaches the damping counterbore 47, the gases 19 are highly laminated by the passage restriction thus formed, such that during the second part of its stroke to the chamber-side valve stop 14, the valve having a guide pin 50 is slowed down, which reduces the power of any impact which could occur between the axial opening face 13 and the chamber-side valve stop 14.

This particular configuration of the valve 50 having a guide pin gives the latter a long service life.

The presence of a permanent return magnet 24 is noted in FIGS. 3 to 5, which forms a “magnetic valve return device”, such as described in French patent application no. 3 085 718.

The permanent return magnet 24 forms a magnetic field source 23 and ensures the reclosure of the guide pin valve 50 after the latter has been opened by the increase in pressure of the gases 19 occurring in the lamination cavity 4, this after a pilot charge 31 has been introduced in said cavity 4 by an electromechanically controlled lamination injector, then ignited by a spark plug 33.

In FIGS. 3 to 5, the electromechanically controlled lamination injector 6 has been shown which comprises an injector needle 75 which, when it lifts from its seat under the action of an electromagnetic injector actuator 76, introduces a pilot charge 31 in the lamination cavity 4.

When the electromagnetic injector actuator 76 stops being powered, the injector needle 75 is returned on its seat by a return needle spring 77, the latter being isolated from the gases 19 constituting the pilot load 31 by a spring isolation seal 78.

As FIGS. 3 to 5 show, the position of the injector needle 75 is permanently returned to a computer not represented by an injector needle position sensor 82, the latter making it possible for said computer to specifically adjust the mass of the pilot charge 31 which is introduced into the lamination cavity 4 by the electromechanically controlled lamination injector 6.

For that, said computer executes software which determines, permanently and from the lifting of the injector needle 75 read by the injector needle position sensor 82, the mass of the pilot load 31 which is introduced into the lamination cavity 4, said software correcting, if necessary, said lifting, such that the pilot load 31 mass actually introduced into the lamination cavity 4 corresponds to that necessary for the optimal operation of the internal combustion engine 79.

It is noted in FIGS. 3 to 5, that the lamination cavity 4 is arranged in an active prechamber ignition insert 42 similar to that described in French patent application no. 1904961 of 13 May 2019 belonging to the applicant, said insert 42 being fixedly maintained in the internal combustion engine cylinder head 2 by insert clamping means 43.

As has been seen, the operation of the guide pin valve 50 in the context of the oriented valve ignition prechamber 1 according to the invention is comparable to that described in the patent no. WO2022079367.

However, contrary to said patent No. WO2022079367 and to what is shown in the initial patent FR 3 061 743 relating to a valve ignition prechamber, and contrary to what is shown in the improvement patents resulting from said initial patent, there is no longer direct contact between the guide pin valve 50 and the non-magnetic prechamber tip 62 but via the friction insert for an oriented valve 60.

This novel configuration avoids having to coat the inside of the non-magnetic prechamber tip 62 with any coating at all, as indeed, the coatings which remain sufficiently hard and resistant to abrasion at high temperatures are notoriously incompatible with copper alloy, of which the non-magnetic prechamber tip 62 is constituted, due to the high temperature at which said coatings are applied, and due to the insufficient hardness of the sub-layer of the substrate which constitutes the copper alloy whatever the grade.

Yet, advantageously, the friction insert for an oriented valve 60 can be made of a material such as “Inconel” which is both, under certain conditions, core-hard, such that it forms a substrate which is more favourable to hard coatings, and which is resistant to high temperatures, such that it can receive a wide range of “DLC”-, “PVD”-type hard coatings, or any type known to a person skilled in the art, in particular to receive a coating of “lonbond 90”-type.

It should be noted that the “Inconel” of which the guide insert 60 for an oriented valve is made, for example, can advantageously be hardened to a depth of between ten and thirty microns by a carbonitriding of the “Kolsterising” type, this treatment being known to be mastered by the company “Bodycote”.

Advantageously, the guide pin valve 50 itself being made of a material preserving a high mechanical resistance at high temperature, such as the “Caldie” with chrome-molybdenum-vanadium magnetic steel from the company “Uddeholm”, said valve 50 can also be covered with any type of anti-abrasion coating, such as the “lonbond 90”.

It follows from the above that the guide insert for an oriented valve 60 that the oriented valve ignition prechamber 1 according to the invention comprises makes it possible to choose mutually compatible coatings, said coatings conferring a long life both to the guide insert for an oriented valve 60, and to the guide pin valve 50 with which it cooperates.

To give a great hammering resistance to the chamber-side valve stop 14 that forms the bottom of the valve damping chamber 18, said stop 14 may advantageously form part of the guide insert for an oriented valve 60 as has been shown in FIGS. 1, 2, 6 and 7, and benefits from the same mechanical resistance and from the same resistance to abrasion as any other part of said insert 60.

Thus, the core and high-temperature surface mechanical characteristics of the material constituting the guide insert for an oriented valve 60 benefit all the functional surfaces of said insert 60 which cooperate with the guide pin valve 50.

Knowing that the guide pin valve 50 evolves in the guide insert for an oriented valve 60 in almost permanent contact with the latter without benefiting from any lubrication, the person skilled in the art can only understand the fundamental advantage represented by the guide insert for an oriented valve 60 according to the invention in the implementation and sustainable operation of the guide pin valve 50, in addition to the geometric and functional characteristics favorable to mass production at lower cost and to the most efficient closure recall of the valve, as described above.

Indeed, the guide pin valve 50 evolves “dry” in the guide insert for an oriented valve 60, and is subjected to an abrasive attack all the more important as foreign bodies such as mineral or carbonaceous particles can be inserted at high temperature between said valve 50 and said insert 60, whether between the outer peripheral circular valve body guide bearing surface 64 and the inner valve body guide cylinder 63, between the outer peripheral circular pin guide bearing surface 66 and the inner orientation pin guide cylinder 65, at the duct closure seat 11 or at the chamber-side valve stop 14.

It will be noted, however, that the carbonaceous deposits that form on the rubbing surfaces of the guide pin valve 50 and the guide insert 60 for an oriented valve can, on the contrary, protect said surfaces, by wearing off instead of the latter, while regenerating during the operation of the internal combustion engine 79.

It will be noted that the example of embodiment of the oriented valve ignition prechamber 1 according to the invention which has just been described is non-limiting and that said prechamber 1 can be applied to fields other than only internal combustion engines.

Said prechamber 1 can, for example, be applied to gas nailers, to firearms, or to any apparatus requiring the ignition of a main charge by means of a pilot charge with the best effectiveness as possible.

The possibilities of the oriented valve ignition prechamber 1 according to the invention are not limited to the applications which have just been described and it must moreover be understood that the above description has been given by way of example only and does not in no way limit the field of the said invention which is not exceeded by replacing the details of execution described by any other equivalent.

1. An oriented valve ignition prechamber (1) arranged in an internal combustion engine cylinder head (2) which caps a combustion chamber (3), comprising:
a lamination cavity (4) in which ignition means (5) and a lamination injector (6) open, the lamination cavity (4) being connected to the combustion chamber (3) by a lamination duct (7) which opens in the combustion chamber (3) in the form of a non-magnetic prechamber tip (62) in which can translate a lamination valve (61) which comprises a main valve body (8) having, on a lamination cavity (4) side, an axial closure face (10) which can cooperate with a duct closure seat (11) arranged in the lamination duct (7) to close the lamination duct, while the lamination valve (61) is oriented by an orientation pin (15) which emerges from the main valve body (8) and which can slide in an axial guide orifice (17), the main valve body (8) and the orientation pin (15) together forming a guide pin valve (50), while the non-magnetic prechamber tip (62) forms with the guide pin valve (50) and when the guide pin valve does not close the lamination duct (7), a torch ignition prechamber (9) which connects the lamination cavity (6) to the combustion chamber (3) via at least one gas ejection orifice (16);
a friction insert (60) for an oriented valve that is fixedly mounted in the non-magnetic prechamber tip (62) and which houses wholly or partly the guide pin valve (50) and the axial guide orifice (17);
at least one outer peripheral circular valve body guide bearing surface (64) arranged as a projection and on the outer periphery of the main valve body (8), the bearing surface (64) being, at least in part, resistant to abrasive wear;
at least one outer peripheral circular pin guide bearing surface (66) arranged as a projection and on the outer periphery of the orientation pin (15), the bearing surface (66) being resistant to abrasive wear;
at least one inner valve body guide cylinder (63) which is arranged in the friction insert for an oriented valve (60) and which houses wholly or partly the main valve body (8), the main valve body being able to translate in the at least one inner valve body guide cylinder (63) in which it is guided by the outer peripheral circular valve body guide bearing surface (64), the inner diameter of the at least one inner valve body guide cylinder (63) being substantially greater than the outer diameter of the bearing surface (64) while the inner surface of the at least one inner valve body guide cylinder (63) is, at least in part, resistant to abrasive wear;
at least one inner orientation pin guide cylinder (65) which the axial guide orifice (17) has and which houses wholly or partly the orientation pin (15), the latter being able to translate in the at least one inner orientation pin guide cylinder (65) in which it is guided by the outer peripheral circular pin guide bearing surface (66), the inner diameter of the at least one inner orientation pin guide cylinder (65) being substantially greater than the outer diameter of the bearing surface (66) while the inner surface of the at least one inner orientation pin guide cylinder (65) is, at least in part, resistant to abrasive wear.

2. The oriented valve ignition prechamber according to claim 1, wherein the friction insert for an oriented valve (60) is made of a non-magnetic material with high thermal and mechanical resistance.

3. The oriented valve ignition prechamber according to claim 3, wherein the friction insert for an oriented valve (60) forms, with an axial opening face (13) oriented towards the combustion chamber (3) that the main valve body (8) has, on the one hand, and with the orientation pin (15), on the other hand, a valve damping chamber (18).

4. The oriented valve ignition prechamber according to claim 3, wherein the axial guide orifice (17) has a damping counterbore (47) at its end which opens into the valve damping chamber (18), the damping counterbore (47) cooperating with a damping shoulder (46) that the orientation pin (15) comprises.

5. The oriented valve ignition prechamber according to claim 4, wherein the damping counterbore (47) is directly or indirectly connected to the combustion chamber (3) by at least one depressurising duct (48).

6. The oriented valve ignition prechamber according to claim 1, wherein the main valve body (8) comprises at its outer periphery a secondary sealing collar (73) in the extension of the outer peripheral circular valve body guide bearing surface (64), the outer diameter of the secondary sealing collar (73) being less than the outer diameter of the bearing surface (64).

7. The oriented valve ignition prechamber according to claim 1, wherein the friction insert for an oriented valve (60) is fixedly mounted in the non-magnetic prechamber tip (62) by means of an elastic washer (51) held in place in the non-magnetic prechamber tip (62) by a circular stop ring (52) housed in a stop ring groove (54) arranged in the non-magnetic prechamber tip (62).

8. The oriented valve ignition prechamber according to claim 7, wherein the axial face of the circular stop ring (52) which is in contact with the elastic washer (51) comprises a locking shoulder (53) which can come into contact with the periphery of the elastic washer (51), the locking shoulder (53) preventing the circular stop ring (52) from leaving the stop ring groove (54).

9. The oriented valve ignition prechamber according to claim 1, wherein the friction insert (60) for an oriented valve is screwed into the non-magnetic prechamber tip (62) by means of an insert thread (34) that the friction insert (60) has, the insert thread (34) cooperating with a prechamber tip thread (35) that the non-magnetic prechamber nose (62) has.

10. The oriented valve ignition precombustion chamber according to claim 1, wherein the friction insert (60) for an oriented valve is divided into three insert parts (37, 38, 39), the first insert part (37) receiving the inner valve body guide cylinder (63), the second insert part (38) forming an insert mounting body (36), and the third insert part (39) receiving the inner orientation pin guide cylinder (65).

11. The oriented valve ignition prechamber according to claim 1, wherein the lamination duct (7) forms a gas ejection tube (25) at the end of which the duct closure seat (11) is arranged while a magnetic field source (23) induces a magnetic field in the gas ejection tube (25), said field attracting the lamination valve (61) towards the gas ejection tube (25) and tending to return the lamination valve (61) into contact with the duct closure seat (11).

12. The oriented valve ignition prechamber according to claim 11, wherein the gas ejection tube (25) receives a non-magnetic insert sleeve (26) on which the duct closure seat (11) is arranged.

13. The oriented valve ignition prechamber according to claim 11, wherein a magnetic flux channeling groove (28) is arranged at the periphery of the gas ejection tube (25) and in the vicinity of the duct closure seat (11).
